(19) United States
(12) Patent Application Publication
(10) Pub. No.: US 2016/0195270 A1
(43) Pub. Date: Jul. 7, 2016

(54) ARRANGEMENT OF A CARBON DIOXIDE GENERATION PLANT, A CAPTURE PLANT AND AN CARBON DIOXIDE UTILIZATION PLANT AND METHOD FOR ITS OPERATION

(71) Applicant: ALSTOM Technology Ltd, Baden (CH)

(72) Inventor: Sanjay Kumar DUBE, Knoxville, TN (US)

(21) Appl. No.: 14/590,364

(22) Filed: Jan. 6, 2015

(51) Int. Cl. F23J 15/02; B01D 53/14

(52) U.S. Cl. CPC F23J 15/02; B01D 53/1475

(57) ABSTRACT

The method for operating an arrangement of a generation plant, a carbon dioxide capture plant and a carbon dioxide utilization plant includes generating carbon dioxide containing flue gas, supplying the carbon dioxide containing flue gas to the capture plant, separating a carbon dioxide stream from the carbon dioxide containing flue gas, supplying the utilization plant with the carbon dioxide stream, supplying the utilization plant with water, generating syngas at the utilization plant, supplying heat discharged from the utilization plant to the generation plant and/or to the capture plant and/or using it within the utilization plant.

### TECHNICAL FIELD

The present invention relates to an arrangement of a carbon dioxide generation plant, a capture plant and a carbon dioxide utilization plant and a method for its operation.

### BACKGROUND

Carbon dioxide generation plants, such as power plants for electric power generation or steel mills or waste incinerators or glass furnace are known. For example power plants comprise an engine connected to an electrical generator that in turn is connected to the electric network. The engine can be a gas turbine, a boiler connected to a steam turbine, etc., i.e. in a number of applications the engines combust a fossil fuel with an oxidizer such as air or pure/substantially pure oxygen to release energy that is converted into mechanical energy at a turbine and into electrical energy at the electrical generator. These engines generate flue gas containing carbon dioxide that is often released into the atmosphere.

Carbon dioxide capture plants are known to counteract carbon dioxide emissions, for example from power plants. These carbon dioxide capture plants implement removal of carbon/carbon dioxide from the fuel/flue gas generated during combustion in order to generate a stream of carbon dioxide, which is then sequestered or stored, for example in underground cavities.

Carbon dioxide utilization plants are also known. These plants use carbon dioxide as a raw material; for example a utilization plant is the plant for generation of syngas from carbon dioxide; in a case like this the utilization plant is supplied with carbon dioxide and, in addition, water and/or thermal energy and/or electric power for generation of syngas.

### SUMMARY

The inventors have found a way for integrating these different plants, such that the discharge products (like carbon dioxide) and/or energy (thermal and/or electrical energy) discharged or emitted from one plant can be used by another plant, such that the global efficiency of the arrangement of carbon dioxide generation plant, carbon dioxide capture plant and carbon dioxide utilization plant is increased.

These and further aspects are attained by providing an arrangement and a method in accordance with the accompanying claims.

### BRIEF DESCRIPTION OF THE DRAWINGS

Further characteristics and advantages will be more apparent from the description of a preferred but non-exclusive embodiment of the arrangement and method, illustrated by way of non-limiting example in the accompanying drawings, in which:

FIG. 1 shows an example of an arrangement, and

FIG. 2 shows a more detailed example of another embodiment of the arrangement.

### DETAILED DESCRIPTION

With reference to the figures, these show an arrangement 1 of a generation plant 2 for generating a carbon dioxide containing flue gas, a carbon dioxide capture plant 3 for separating a carbon dioxide stream from carbon dioxide containing flue gas, and a carbon dioxide utilization plant 4 for producing syngas 5 by reaction of carbon dioxide with water.

The generation plant 2 can be any generation plant that discharges carbon dioxide. For example the generation plant 2 can be a power plant in which a fossil fuel is combusted or used in any way to generate heat and/or power generating flue gas containing carbon dioxide. Typically these kinds of plants include gas turbines connected to an electrical generator and/or steam turbines connected to an electrical generator and supplied with steam by a boiler. The attached figures show the fuel 8 that is supplied to the generation plant 2 (together with an oxidizer such as air or pure or substantially pure oxygen). In addition, the generation plant can also be a plant different from a power plant, such as a steel mill or a waste incinerator or other kinds of plants such as glass furnaces that discharge carbon dioxide containing flue gas.

The arrangement 1 further comprises ducting 9 for forwarding carbon dioxide containing flue gas from the generation plant 2 to the capture plant 3 (the flue gas before entering the capture plant 3 can travel through the traditional air pollution control system such as particulate collectors, Selective Catalytic Reduction unit, Flue Gas Desulfurization unit, etc.—not shown).

The capture plant 3 can be of any types, possible examples of capture plants 3 are post combustion capture plants such as chilled ammonia or amine capture plants; other examples are anyhow possible, such as gas processing units (for example associated to oxyfuel combustion at the generation plant, but this is not mandatory); in this case the reference 3 identifies the gas processing unit (for compressing and cooling the flue gas in order to separate carbon dioxide) and possible additional devices for flue gas treatment.

The capture plant 3 (independently from its specific technology) is able to receive flue gas containing carbon dioxide and other gas (e.g. argon, nitrogen, oxygen, etc.) and separate a carbon dioxide stream (i.e. a stream containing a high percentage by volume of carbon dioxide such as at least 40%, preferably at least 50%, more preferably at least 60%, more preferably at least 70%, more preferably at least 80%, more preferably at least 90%, more preferably at least 95% carbon dioxide).

The arrangement further comprises ducting 11 for forwarding the carbon dioxide stream separated at the capture plant 3 from the capture plant 3 to the utilization plant 4.

The utilization plant 4 is a dissociation plant in with carbon dioxide is dissociated in presence of water to generate syngas (mixture of CO and H₂) according to the reaction

CO₂+H₂O→CO+H₂+O₁.

For this reason the utilization plant 4 is also provided with ducting 12 for supplying the utilization plant 4 with water.

The power needed to run this endothermic reaction is a combination of electrical and thermal power both to be supplied to the reactor in which reaction is occurring. The technology is based on electrolysis performed at an elevated temperature of about 800° C. using solid oxide fuel cell (SOFC) technology running in electrolysis mode.

The advantage of performing electrolysis in this form is a substantial reduction in the electrical power consumption in comparison with room temperature electrolysis. The higher the temperature the lower is the Gibbs free energy (supplied in the form of electricity) than the enthalpy of the dissociation; the gap is supplied in the form of thermal energy.

The reaction occurs in solid oxide fuel cells. These cells have a membrane defining the external surface and made of a solid oxide. The membrane encloses a chamber into which CO₂ and H₂O (reaction gas) enter. An external voltage is thus applied on the membrane, such that the CO and H₂ remain within the chamber while the oxygen ions O²⁻ pass through the membrane to a common cavity where they become O₂.

In order to supply thermal power, a flow of hot working gas (more than 800° C., for example about 1000° C.) is made to pass through the solid oxide fuel cells in order to heat them. The O₂ produced by the solid oxide fuel cell can be mixed to the reaction gas (CO₂ and H₂O) or can be recovered separately.

Preferably the reaction gas is preheated before entering the solid oxide fuel cell by a heat recovery from e.g. the hot syngas generated at the utilization plant 3.

The arrangement further has ducting 13 for transferring heat from the utilization plant 4 to the generation plant 2 and/or for its utilization within the utilization plant 3 and/or ducting 50 for transferring heat from the utilization plant 4 to the capture plant 3.

In different embodiments, the generation plant 2 can be a power plant for electric power generation (for example, as described above, with gas turbine or boiler and steam turbine), but the generation plant can also be a steel mill or waste incinerator or glass furnace or any other industrial plant which discharges carbon dioxide or involves combustion of fossil fuel.

The capture plant 3 is preferably a post combustion capture plant (such as an amine or chilled ammonia capture plant).

Preferably, a ducting 14 is provided for transferring low grade heat discharged from the generation plant 2 (such as a power plant) to the capture plant 3.

The arrangement can also have ducting 15 for transferring heat discharged from the generation plant 2 to the utilization plant 4 and, in case the generation plant is a power plant, electric connections 16 for transferring at least part of the electric power generated at the power plant to the utilization plant 4.

Heat transfer is generally made by heat vector fluids, such that the ducting is used to convey the heat vector fluid. Then heat exchangers can be provided for the heat vector fluid to acquire or release the heat; for example direct contact of the heat vector fluid with surfaces that are heated or cooled by another fluid is possible.

The electric connections 16 generally include cables for high/medium/low voltage, disconnectors, etc. according to the needs.

The operation of the arrangement is apparent from that described and illustrated and is substantially the following. In the following reference to a generation plant 2 being a power plant for electric power generation is made.

Fuel 8 and oxidizer such as air or oxygen are supplied to the power plant 2 generating electric power and carbon dioxide containing flue gas. The carbon dioxide containing flue gas is forwarded via ducting 9 to the capture plant 3 where carbon dioxide is separated from other gas and a carbon dioxide stream is forwarded to the utilization plant 4 via ducting 11. Other gas contained in the carbon dioxide containing flue gas (such as for example argon, nitrogen, oxygen, etc.) can be used in other way or can be vented into the atmosphere via a line 17.

At the utilization plant 4 the carbon dioxide is reacted with water (that can be pre-heated) supplied via the ducting 12 in order to generate syngas according to the reaction

CO₂+H₂O→CO+H₂+O₂

with heat at high temperature (e.g. about 1000° C.) and electric power being supplied from the power plant 2 via the ducting 15 and electric connections 16.

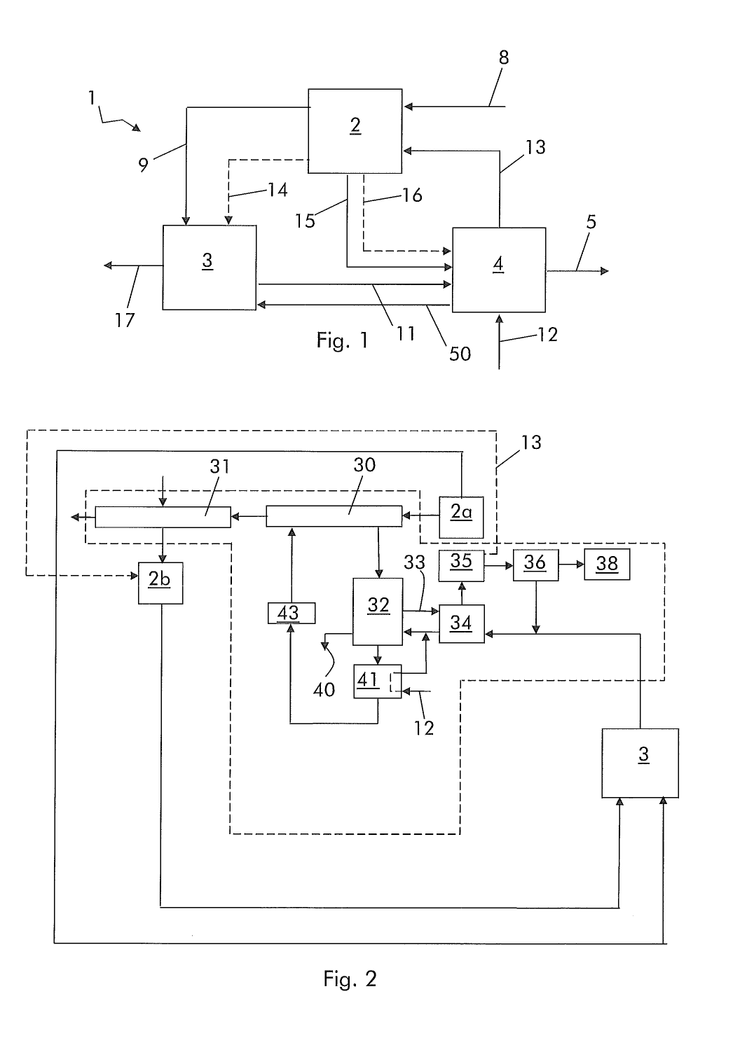

From the utilization plant 4 heat is discharged (because the syngas generated at the utilization plant 4 has a high temperature (e.g. higher than 500° C.) after the reaction that causes its generation), this heat can be reused in the power plant 2 or capture plant 3; for example FIG. 1 shows the heat discharged at a temperature of e.g. about 500° C. from the utilization plant 4 and supplied to the generation plant 2 via ducting 13 (for example if the power plant 2 has a boiler connected to a steam turbine, the heat from the utilization plant 4 can be used at the superheater or reheater or also for water evaporation) and to the capture plant 3 via ducting 50.

In addition, also the syngas can be reused in the arrangement; for example the syngas can be combusted in the power plant 2 (i.e. the syngas can be the fuel supplied to the power plant 2 or a part of it). As an alternative the syngas can also be used in any other way or sold.

Low temperature heat is supplied from the generation plant 2 to the capture plant 3 via the ducting 14; this heat has a low temperature that is selected according to the needs of the capture plant 3; for example the heat forwarded from the generation plant 2 to the capture plant 3 has a temperature of 120-200° C.

FIG. 2 shows a particular embodiment with a generating plant 2a being a steel mill or a waste incinerator or a glass furnace able to generate high temperature gas. Carbon dioxide containing flue gas from the generation plant 2a is forwarded through a first heat exchanger 30 where it is cooled against a fluid such as carbon dioxide or air or other fluid, and a second heat exchanger 31 where it is cooled in order to preheat a fluid supplied into a generating plant 2b such as a power plant.

The fluid such as carbon dioxide is heated by indirectly exchanging heat in the heat exchanger 30 with the flue gas. The heated fluid is then forwarded to a reactor 32 where it heats (by indirectly exchanging heat) the carbon dioxide/water mixture (and possibly syngas also contained in the reactor 32) that is reacting in the reactor 32, in order to run the reaction

CO₂+H₂O→CO+H₂+O₂.

Syngas (mixture of CO and H₂) is removed from the reactor 32 via the line 33 and cooled in a heat exchanger 34 against the gas mixture directed into the reactor 32; syngas is further cooled in the heat exchanger 35 and the heat removed from it is supplied to the generating plant 2b via the line 13, for example to evaporate steam or in the reheater or superheater or where needed according to the temperatures; as an alternative or in addition the heat removed from the syngas can be directly forwarded to the capture plant 3, e.g. for removing a carbon dioxide stream from the carbon dioxide containing solution (regeneration). After cooling syngas is further treated in step 36 in order to remove water or other gas and obtain substantially pure syngas that is collected in step 38 for storage, sale, or use in the generating plants 2a and/or 2b. Carbon dioxide from the capture plant 3 is mixed with the gas removed from the syngas at step 36 and is forwarded through the heat exchanger 34 and after possibly mixing with additional water (preferably preheated water) supplied via ducting 12, it is supplied into the reactor 32.

From the reactor 32 a gas mixture containing oxygen (with possibly other gas contained in the reactor 32) is removed via a line 40. This mixture can be cooled and stored or sold or used in an oxycombustion process.

The fluid such as carbon dioxide having passed through the rector 32 is then cooled downstream of the reactor 32 in a heat exchanger 41, e.g. against water to be supplied into the reactor 32; the fluid is then circulated via the pump 43 back through the heat exchanger 30 in order to define a closed loop.

Advantageously the carbon dioxide containing flue gas from the generating plants 2a (steel mill or waste incinerator or glass furnace) and 2b (steam power plant) are forwarded to the capture plant 3. In addition, the generating plant 2b is preferably an oxyfuel power plant, i.e. a power plant in which a fuel is combusted with substantially pure oxygen or a mixture of carbon dioxide and oxygen for example in a boiler.

In an alternative embodiment in which the heat collected at the utilization plant 4 is used within the utilization plant 4 itself, ducting for supplying a heat vector fluid or the syngas from the heat exchanger 35 to the reactor 32 can be provided instead of or in addition to the ducting 13, for pre-heating the reactor 32.

The present invention also refers to a method for operating an arrangement 1 of a generation plant 2 for generating a carbon dioxide containing flue gas, a carbon dioxide capture plant 3 for separating a carbon dioxide stream from carbon dioxide containing flue gas, a carbon dioxide utilization plant 4 for producing syngas by reaction of carbon dioxide with water.

The method comprises

generating carbon dioxide containing flue gas at the generation plant 2,

supplying the carbon dioxide containing flue gas from the generation plant 2 to the capture plant 3,

separating a carbon dioxide stream from the carbon dioxide containing flue gas at the capture plant 3,

supplying the utilization plant 4 with the carbon dioxide stream,

supplying the utilization plant 4 with water,

generating syngas at the utilization plant 4,

supplying heat discharged from the utilization plant 4 to the generation plant 2 and/or to the capture plant 3 and/or using it within the utilization plant.

In addition, preferably the method comprises supplying heat discharged from the generation plant 2 to the capture plant 3 and/or to the utilization plant 4 and, when the generation plant 2 is a power plant, supplying at least part of the electric power generated by the power plant to the utilization plant 4.

Therefore, an improved efficiency can be obtained in the heat utilization because the waste heat from the carbon dioxide utilization plant 4 is used in the carbon dioxide capture plant 3 to reduce the heat demand for the carbon dioxide capture process and/or it is used in the generation plant 2, e.g. to produce electricity. The heat recovered from the carbon dioxide utilization plant 4 is of high quality (450-500° C. or more) and the heat requirement in the carbon dioxide capture plant 3 is between 120-160° C. (post combustion carbon dioxide capture) and hence sending the heat from the utilization plant to the generation plant and using the less valuable heat from the generation plant to the carbon dioxide capture plant saves the overall exergy losses of the system.

Naturally the features described may be independently provided from one another.

In practice the materials used and the dimensions can be chosen at will according to requirements and to the state of the art.

1. An arrangement of a generation plant for generating a carbon dioxide containing flue gas, a carbon dioxide capture plant for separating a carbon dioxide stream from carbon dioxide containing flue gas, a carbon dioxide utilization plant for producing syngas by reaction of carbon dioxide with water, comprising
ducting for forwarding carbon dioxide containing flue gas from the generation plant to the capture plant,
ducting for forwarding a carbon dioxide stream from the capture plant to the utilization plant,
ducting for supplying the utilization plant with water,
ducting for transferring heat from the utilization plant to the generation plant and/or for its utilization within the utilization plant and/or
ducting for transferring heat from the utilization plant to the capture plant.

2. The arrangement of claim 1, wherein the generation plant is a power plant for electric power generation.

3. The arrangement of claim 1, wherein the generation plant is a steel mill or waste incinerator or glass furnace or any other industrial processes which involves combustion of fossil fuel.

4. The arrangement of claim 1, wherein the capture plant is a post combustion capture plant.

5. The arrangement of claim 1, further comprising ducting for transferring heat discharged from the generation plant to the capture plant.

6. The arrangement of claim 1, further comprising ducting for transferring heat discharged from the generation plant to the utilization plant.

7. The arrangement of claim 2, further comprising electric connections for transferring at least part of the electric power generated at the power plant to the utilization plant.

8. A method for operating an arrangement of a generation plant for generating a carbon dioxide containing flue gas, a carbon dioxide capture plant for separating a carbon dioxide stream from carbon dioxide containing flue gas, a carbon dioxide utilization plant for producing syngas by reaction of carbon dioxide with water, comprising
generating carbon dioxide containing flue gas at the generation plant,
supplying the carbon dioxide containing flue gas from the generation plant to the capture plant,
separating a carbon dioxide stream from the carbon dioxide containing flue gas at the capture plant,
supplying the utilization plant with the carbon dioxide stream,
supplying the utilization plant with water,
generating syngas at the utilization plant,
supplying heat discharged from the utilization plant to the generation plant and/or to the capture plant and/or using it within the utilization plant.

9. The method of claim 8, wherein the generation plant is a power plant for electric power generation,

10. The method of claim 8, further comprising supplying heat discharged from the generation plant to the capture plant.

11. The method of claim 8, further comprising supplying heat discharged from the generation plant to the utilization plant.

12. The method of claim 9, further comprising supplying at least part of the electric power generated at the power plant to the utilization plant.
